(19) United States
(12) Patent Application Publication
(10) Pub. No.: US 2020/0369255 A1
(43) Pub. Date: Nov. 26, 2020

(54) ANGLE COCK THAT DOES NOT REQUIRE TOOLS FOR REPAIR

(71) Applicant: NEW YORK AIR BRAKE LLC, Watertown, NY (US)

(72) Inventors: Steven Newton, Adams, NY (US); Jerome O'Rourke, Henderson, NY (US); Danial Rowland, Adams Center, NY (US)

(73) Assignee: NEW YORK AIR BRAKE LLC, Watertown, NY (US)

(21) Appl. No.: 16/421,689

(22) Filed: May 24, 2019

(51) Int. Cl. B60T 17/04

(52) U.S. Cl. CPC B60T 17/043

(57) ABSTRACT

the present invention involves several approaches for coupling the cover of the angle cock to the main body of the angle cock to avoid the need for tools to effect a repair of the angle cock. The angle cock has a main body with a brake pipe inlet, a brake pipe outline, and a mouth positioned between the brake pipe inlet and the brake pipe outlet. A ball valve positioned in the main body to selectively permit communication between the brake pipe inlet and the brake pipe outlet and has a stem extending out of the mouth. A cover is positioned in covering relation to the mouth to seal the mouth and the stem. The cover and mouth include corresponding structure to ensure a tight seal and to interlock the cover and main body together in a way that can be unlocked without tools.

### BACKGROUND OF THE INVENTION

### 1. FIELD OF THE INVENTION

The present invention to rail car angle cocks and, more specifically, to an angle cock design that can be repaired in the field without the need for tools.

### 2. DESCRIPTION OF THE RELATED ART

Angle cocks are used on all types of conventional freight and intermodal rails, as well as locomotives, for attachment to the brake pipe so that the brake pipe may be selectively opened or closed. When an angle cock fails in the field, however, the entire device must be repaired by the appropriate individuals before the train can be driven as the brake pipe will not operate properly. A field repair of an angle cock, however, is difficult because it requires the use of tools that may not be readily available, thereby further delaying the train. Accordingly, there is a need in the art for an angle cock that can be easily repaired without the need for tools.

### BRIEF SUMMARY OF THE INVENTION

The present invention comprises several approaches for coupling the cover of the angle cock to the main body of the angle that avoids the need for specialized tool and, in many circumstances, any tool at all to effect a repair of the angle cock. The angle cock generally comprises a main body having a brake pipe inlet, a brake pipe outline, and a mouth positioned between the brake pipe inlet and the brake pipe outlet as well as a ball valve positioned in the main body to selectively permit communication between the brake pipe inlet and the brake pipe outlet and having a stem extending out of the mouth. A cover is positioned in covering relation to the mouth to seal the mouth and the stem. The cover includes a first structure and the mouth includes a second structure that interlocks with the first structure to retain the cover in covering relation to the mouth.

In a first embodiment, the first structure comprises a lip extending from a peripheral edge of the cover and the second structure comprises a flange spaced apart from the mouth sufficiently to securely engage the lip. The first structure may also comprise a second lip extending from the peripheral edge of the cover and spaced apart from the first lip by a gap and the second structure may also comprise a second flange positioned opposite from the first flange.

In another embodiment, the first structure may comprise a first flange and the second structure may comprise a second flange. A V-band is positioned in covering relation to the first flange and the second flange.

In an additional embodiment, the first structure may comprise a helical groove formed into a receiver and the second structure may comprise a boss having a tab extending outwardly to engage the helical groove. A plunger may be associated with the main body and having a pin that extends to engage a corresponding hole formed in the cover.

In a further embodiment, the first structure may comprise an ear extending from the cover and the second structure may comprise an annular groove formed in an upper face of the mouth in which the ear is captured. A plunger may be associated with the main body and having a pin that extends to engage a corresponding hole formed in the ear.

In yet another embodiment, the first structure may comprise a pair of ears extending from the cover and the second structure may comprise a pair of slots formed in an upper face of the mouth in which the pair of ears are captured. A pair of plungers may be associated with the main body, wherein each of the pair of plungers has a pin that extends to engage a corresponding hole formed in each of the pair of ears.

In yet a further embodiment, the first structure may comprise an annular groove extending helically in a boss and the second structure may comprise a pin extending into the mouth to engage the annular groove. A detent may be positioned in the annual groove.

In yet an additional embodiment, the first structure may comprise a ring positioned over the cover and having a pin projecting inwardly and the second structure may comprise an annular groove extending helically in an outer surface of the mouth.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of an embodiment of an angle cock according to the present invention;

FIG. 2 is an exploded view of a portion of an angle cock according to the present invention;

FIG. 3 is an exploded view of the cover and the mouth of the main body of an angle cock according to the present invention;

FIG. 4 is an perspective view of a cover and the mouth of a main body of an angle cock in an interlocked position according to the present invention

FIG. 5 is a perspective view of another embodiment of an angle cock according to the present invention;

FIG. 6 is an perspective view of the cover and the mouth of a main body of the angle cock of FIG. 5 in an interlocked position and coupled by a V-band according to the present invention;

FIG. 7 is an perspective view of the cover and the mouth of a main body of the angle cock of FIG. 5 in an interlocked position according to the present invention;

FIG. 8 is a perspective view of a further embodiment of an angle cock according to the present invention;

FIG. 9 is a perspective view of a portion of a cover for the angle cock of FIG. 8.

FIG. 10 is a perspective view of a portion of the mouth of the main body for the angle cock of FIG. 8;

FIG. 11 is a perspective view of the cover and the mouth of the main body of the angle cock of FIG. 8 in the interlocked position;

FIG. 12 is a perspective view of an additional embodiment of an angle cock according to the present invention;

FIG. 13 is a perspective view of a portion of a cover for the angle cock of FIG. 12.

FIG. 14 is a perspective view of a portion of the mouth of the main body for the angle cock of FIG. 12;

FIG. 15 is a perspective view of the cover and the mouth of the main body of the angle cock of FIG. 12 in the interlocked position;

FIG. 16 is a perspective view of yet another embodiment of an angle cock according to the present invention;

FIG. 17 is a perspective view of a portion of a cover for the angle cock of FIG. 16.

FIG. 18 is a perspective view of a portion of the mouth of the main body for the angle cock of FIG. 16;

FIG. 19 is a perspective view of the cover and the mouth of the main body of the angle cock of FIG. 16 in the interlocked position;

FIG. 20 is a perspective view of yet a further embodiment of an angle cock according to the present invention;

FIG. 21 is a perspective view of a cover for the angle cock of FIG. 20.

FIG. 22 is a perspective view of the main body for the angle cock of FIG. 20;

FIG. 23 is a perspective view of yet an additional embodiment of an angle cock according to the present invention;

FIG. 24 is a perspective view of a cover for the angle cock of FIG. 23.

FIG. 25 is a perspective view of the main body for the angle cock of FIG. 23;

FIG. 26 is a perspective view of yet a further embodiment of an angle cock according to the present invention; and

FIG. 27 is an exploded view of the angle cock of FIG. 26.

### DETAILED DESCRIPTION OF THE INVENTION

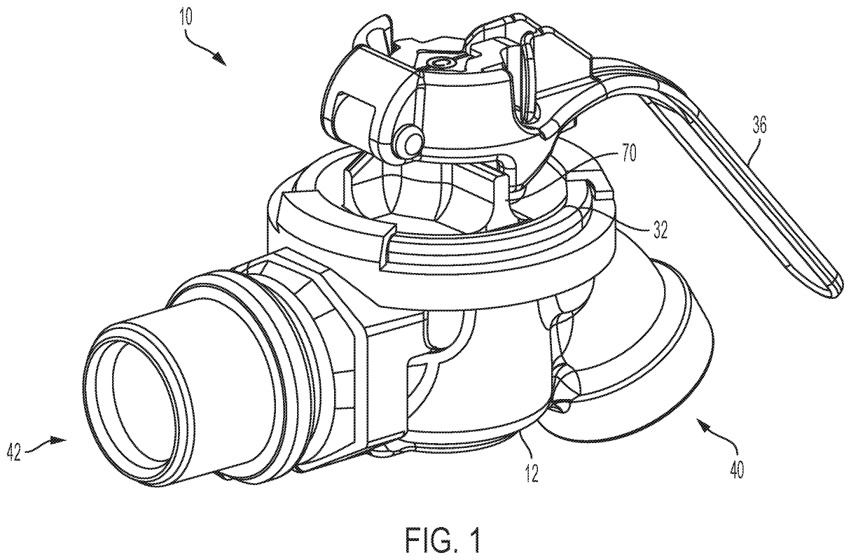

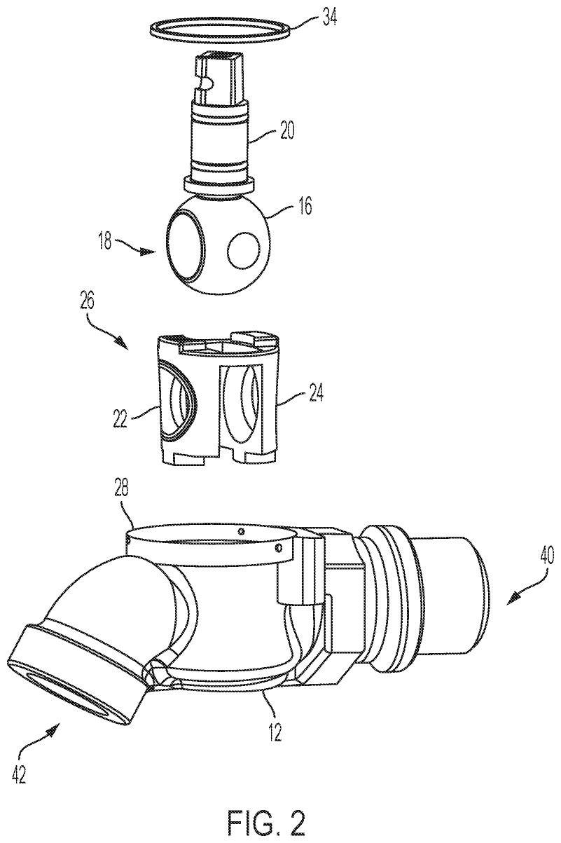

Referring to the figures, wherein like numeral refer to like parts throughout, there is seen in FIG. 1 an angle cock 10 that can be repaired without the use of separate tools. As detailed in FIG. 2, angle cock 10 comprises a main body 12 housing a ball key 14 having a ball 16 with a throughbore 18 and a ball key shaft 20 extending upwardly from ball 16. Ball 16 is positioned between two ball seats 22 and 24, shown in FIG. 2 as formed integrally into a ball seat assembly 26. Ball key shaft 20 extends through a mouth 28 of main body 12 and through an opening 30 in a cover 32 that is secured over mouth 28 to securely seal ball 16 in main body 12. A gasket 34 may be positioned between cover 32 and main body 12 to provide an air-tight seal between cover 32 and main body 12. As is known in the field, ball 16 is selectively moveable between open and closed positions to selectively open and close communication between an inlet 40 of main body 12 positioned upstream of ball 16 to an outlet 42 positioned downstream of ball 16. Position of ball 16 and, more specifically, the orientation of throughbore 18 of ball 16 selectively allows or prohibits the flow or air from inlet 40 to outlet 42, thereby allowing a user to selectively open or close communication with a brake pipe coupled to inlet 30, such as by rotating ball key 14 with a handle 36 coupled to ball key shaft 20.

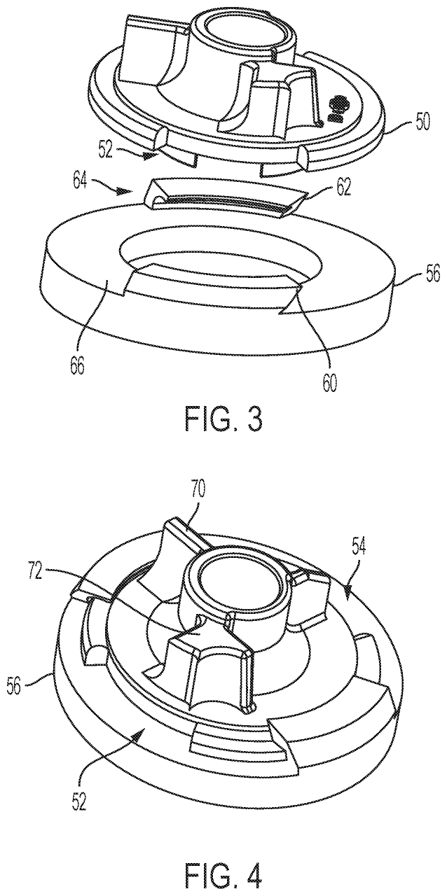

Referring to FIGS. 3 and 4, cover 32 may be secured to main body 12 without the use of fasteners, such as bolts, thereby avoiding the need for a user to have a special tool available when servicing angle cock 10. More specifically, cover 32 includes a lip 50 extending circumferentially from the perimeter of cover 32. Lip 50 is interrupted by two opposing gaps 52 and 54 positioned about cover 32. Mouth 28 of main body 12 includes a coupling ring 56 extending around mouth 28 and supporting a pair of flanges 60 and 62 that are spaced apart from coupling ring 56 and positioned oppositely about coupling ring 56 to define a receiving gaps 64 and 66 for securely receiving lip 50. Flanges 60 and 62 are dimensioned and positioned to fit between opposing gaps 52 and 54 so that cover 32 may be positioned directly against coupling ring 56 with gaps 52 and 54 in alignment with flanges 60 and 62 so that cover 32 may be positioned in abutment with coupling ring 56. Cover 32 may then be rotated relative to coupling ring 56 so that flanges 60 and 62 are moved into receiving gaps 64 and 66 and are securely held therein against any internal forces when main body 12 is under pressure from the pressurization of a brake pipe coupled to inlet 40. Cover 32 may be opened without the use of tools by rotating cover 32 relative to main body 12 until flanges 60 and 62 are released from receiving gaps 64 and 66. Cover 32 may be manually rotated in either direction using stops 70 and 72 that are positioned to engage handle 36 when it is rotated into the fully open and closed positions.

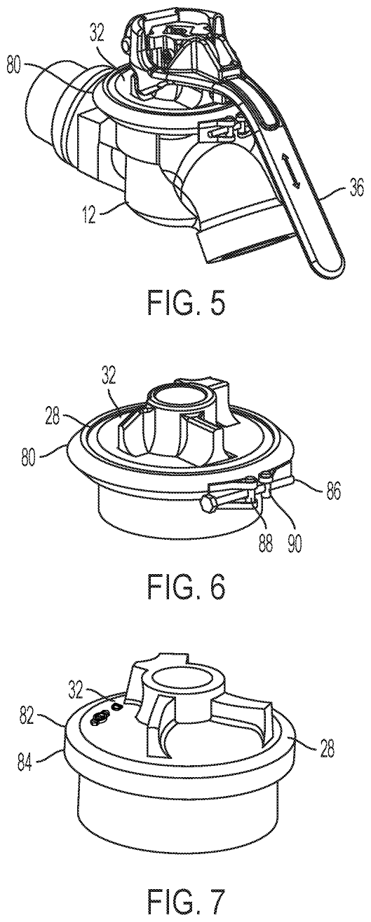

Referring to FIGS. 5 through 7, in another embodiment, cover 32 may be secured to main body 12 via a V-band clamp 80 that encompasses the outer perimeters of both cover 32 and mouth 28. In this embodiment, cover 32 is configured to mount flushly to mouth 28 and the outer perimeter of both cover 32 and mouth 28 are shaped as corresponding V-shaped flanges 82 and 84 to accept V-band clamp 80 thereover. V-band clamp 80 may be tightened and secured over V-shaped flanges 82 and 84 with a standard bolt 86 and dual trunnion 88 and 90 arrangement.

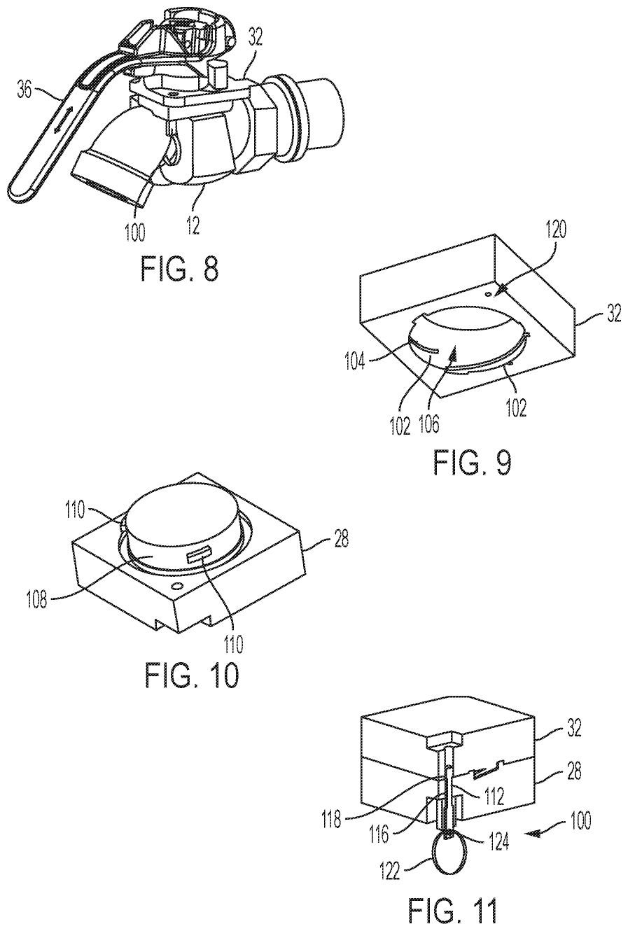

Referring to FIGS. 8 through 11, in a further embodiment, cover 32 may be secured to main body 12 using a spring loaded plunger 100 coupled to main body 12. In this embodiment, cover 32 include one or more helically extending annular grooves 102 extending along the inner wall 104 of a receiver 106 formed into cover 32. Main body 12 includes a cylindrical boss 108 having circumferentially tabs 110 extending outwardly from boss 108 that correspond to ramped annular grooves 102 so that tabs 110 will extend into grooves 102 and slide therealong as receiver 106 of cover 32 is rotated over boss 108. Helical orientation of annular grooves 102 will secure cover 32 to main body 12 during rotation and, when fully rotated together, a moveable pin 112 of plunger 100 that is supported in a housing 114 is biased by a spring 116 so that a first end 118 of pin 112 extends outwardly into a corresponding hole 120 in cover 32 to lock cover 32 against counter rotation, thereby securing cover 32 to main body 12. Cover 32 may be released from main body 12 by manually withdrawing pin 112, such as by pulling a ring 122 attached to the opposing end of pin 112 against the bias of spring 116 to disengage first end 118 of pin 112 from hole 120.

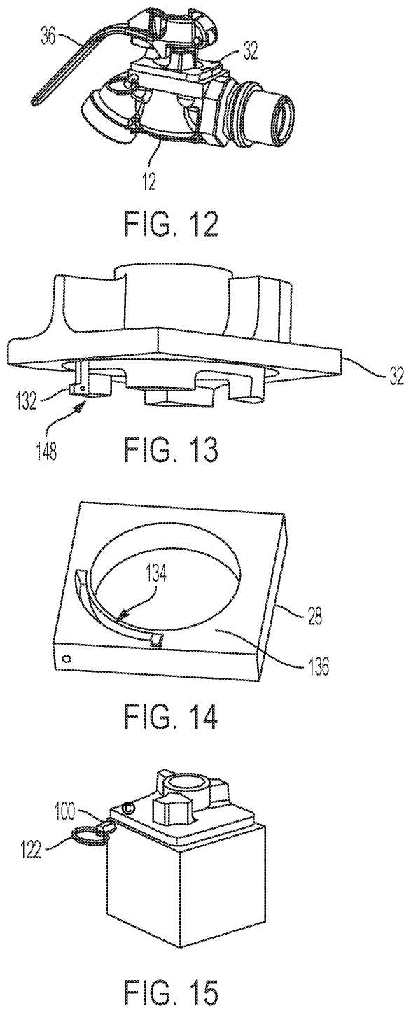

Referring to FIGS. 12 through 15, cover 32 may be secured to main body 12 using a spring loaded plunger 100 that locks cover 32 in place after an ear 132 extending from cover 32 has been rotated through an annular groove 134 formed in an upper face 136 of mouth 28 of main body 12. Groove 134 extends from a first position, where cover 32 is unlocked from and free to separate from main body 12, to a second position, where ear 132 of cover 32 may be selectively retained in place by spring loaded plunger 130 and thus locked in place against main body 12. As described above, spring loaded plunger 100 having a pin 112 biased outwardly by a spring 116 so that a first end 118 can engage ear 132. Ear 132 may include a hole 148 formed therein to accept first end 118 of pin 112. A pull ring 122 coupled to a second end 124 of pin 112 allows for manual disengagement of pin 112 from ear 132 so that cover 32 can be rotated into the first positioned and thus unlocked from main body 12.

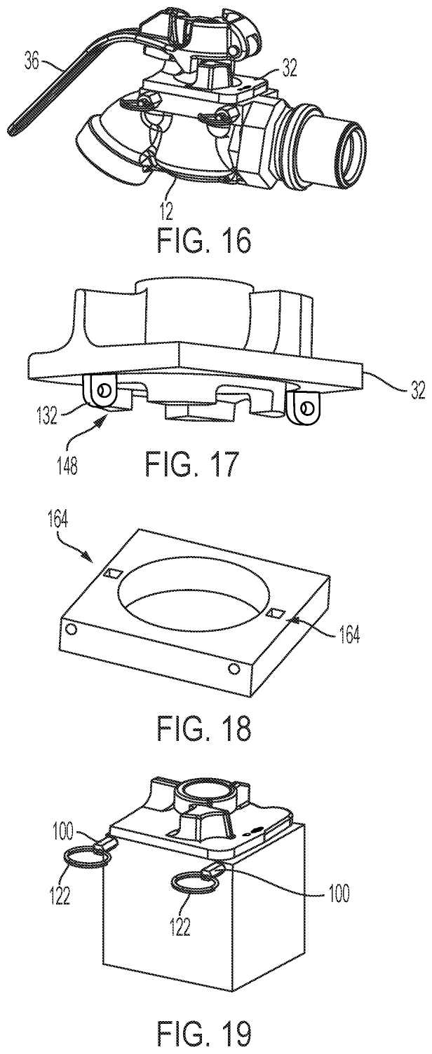

Referring to FIGS. 16 through 19, cover 32 may be secured to main body 12 using a pair of spring loaded plungers 100 to lock cover 32 in place by engaging a pair of corresponding ears 162 that extend from cover 32 into slots 164 that are formed into main body 12 and aligned with spring loaded plungers 100 so that pins 112 of plungers 100 can extend into ears 162 to lock cover 32 into place against main body 12.

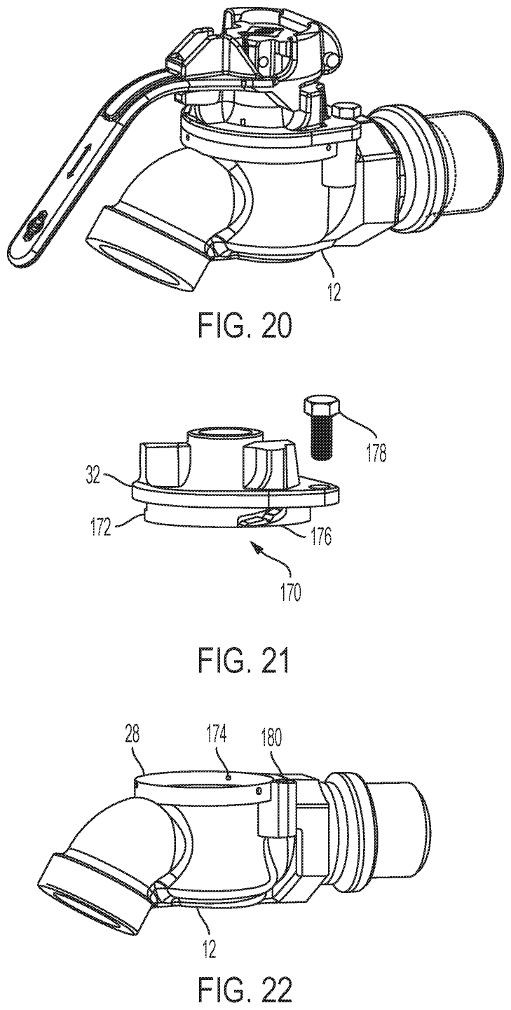

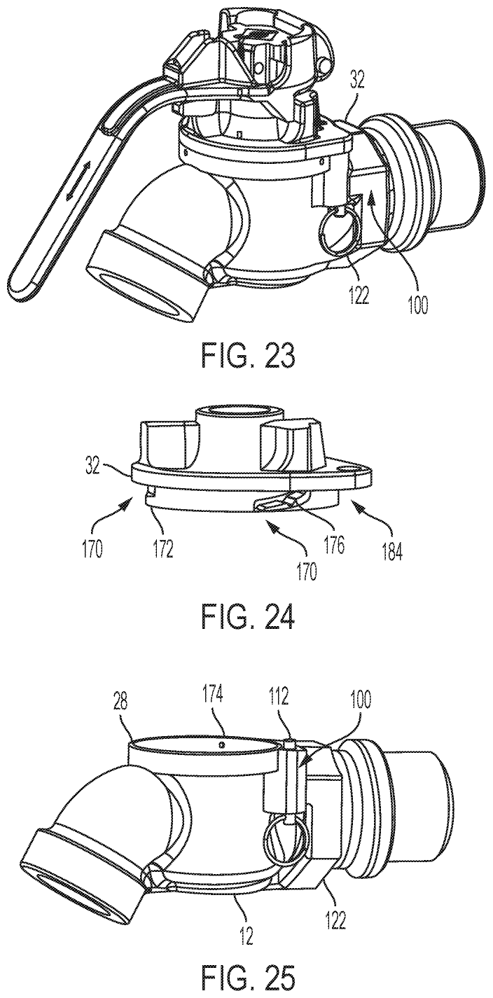

Referring to FIGS. 20 through 22, cover 32 may be secured to main body 12 using a series of annular grooves 170 that extend helically from a boss 172 extending from cover 32. A series of pins 174 extend inwardly from mouth 28 and are accepted into grooves 170 when cover 32 and mouth 28 are coupled together. A detent 176 may be associated with each groove 170 to ensure cover 32 is rotated far enough to fully seat against main body 12. When cover 32 is fully seated, cover 32 may be secured to main body 12 with a hexagonal head screw 178 that extends through cover 32 and is received in a boss 180 of main body 12. Alternatively, as seen in FIGS. 23 through 25, cover 32 may be secured in the fully closed position using a spring loaded plunger 100 positioned in main body 12 and having spring loaded pin 112 for engaging a corresponding hole 184 in cover 32.

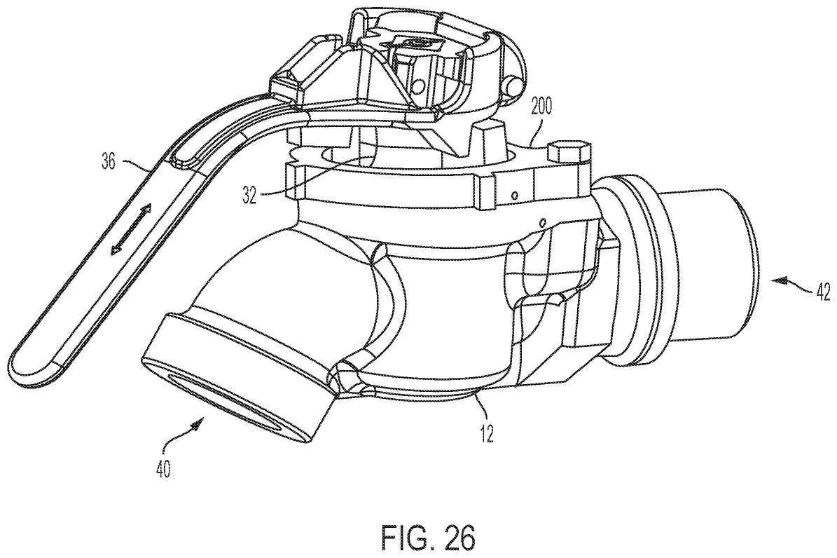

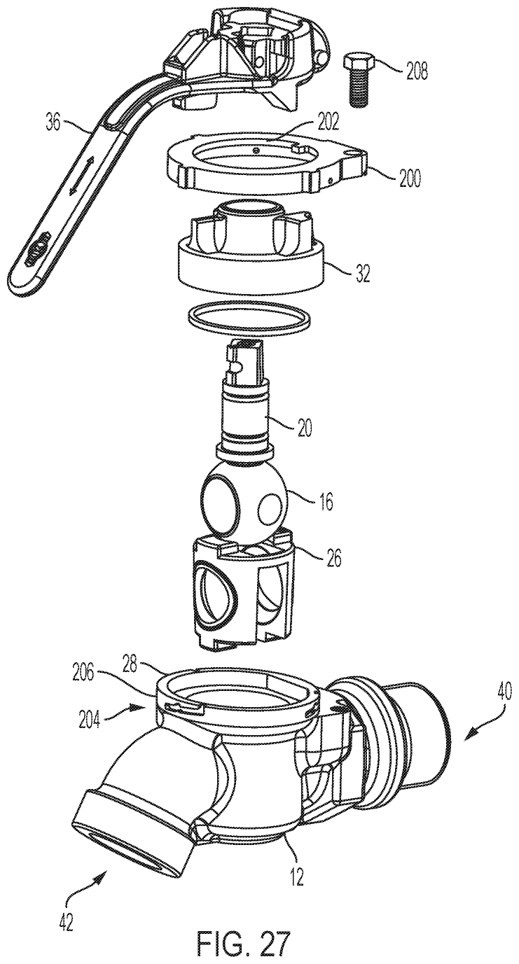

Referring to FIGS. 26 and 27, cover 32 may be secured to main body 12 using an annular ring 200 that is positioned over cover 32 and locked to main body 12. Annular ring 200 has a series of pins 202 that project inwardly and are positioned to engage a series of helical annular grooves 204 formed into the outside surface 206 of mouth 28. Rotation of annular ring 200 causes pins 202 to traverse grooves 204 until cover 32 is secured against main body 12. Cover 32 may be locked into position using the various approaches described herein, such as hex bolt 208, or a spring loaded plunger such as spring loaded plunger 100 positioned in main body 12 and having a spring loaded pin 112 for engaging a corresponding hole 184 in cover 32.

What is claimed is:

1. An angle cock, comprising:
a main body having a brake pipe inlet, a brake pipe outlet, and a mouth positioned between the brake pipe inlet and the brake pipe outlet;
a ball valve positioned in the main body to selectively permit communication between the brake pipe inlet and the brake pipe outlet and having a stem extending out of the mouth;
a cover positioned in covering relation to the mouth to seal the mouth and the stem; and
wherein the cover includes a first structure and the mouth includes a second structure that interlocks with the first structure to retain the cover in covering relation to the mouth.

2. The angle cock of claim 1, wherein the first structure comprises a first lip extending from a peripheral edge of the cover and the second structure comprises a first flange spaced apart from the mouth sufficiently to securely engage the lip.

3. The angle cock of claim 2, wherein the first structure comprises a second lip extending from the peripheral edge of the cover and spaced apart from the first lip by a gap and the second structure comprises a second flange positioned opposite from the first flange.

4. The angle cock of claim 1, wherein the first structure comprises a first flange and the second structure comprises a second flange.

5. The angle cock of claim 4, further comprising a V-band positioned in covering relation to the first flange and the second flange.

6. The angle cock of claim 1, wherein the first structure includes a helical groove formed into a receiver and the second structure comprises a boss having a tab extending outwardly to engage the helical groove.

7. The angle cock of claim 6, further comprises a plunger associated with the main body and having a pin that extends to engage a corresponding hole formed in the cover.

8. The angle cock of claim 1, wherein the first structure comprises an ear extending from the cover and the second structure comprises an annular groove formed in an upper face of the mouth in which the ear is captured.

9. The angle cock of claim 8, further comprises a plunger associated with the main body and having a pin that extends to engage a corresponding hole formed in the ear.

10. The angle cock of claim 1, wherein the first structure comprises a pair of ears extending from the cover and the second structure comprises a pair of slots formed in an upper face of the mouth in which the pair of ears are captured.

11. The angle cock of claim 10, further comprises a pair of plungers associated with the main body, wherein each of the pair of plungers has a pin that extends to engage a corresponding hole formed in each of the pair of ears.

12. The angle cock of claim 1, wherein the first structure comprises an annular groove extending helically in a boss and the second structure comprises a pin extending into the mouth to engage the annular groove.

13. The angle cock of claim 12, further comprises a detent in the annual groove.

14. The angle cock of claim 1, wherein the first structure comprises a ring positioned over the cover and having a pin projecting inwardly and the second structure comprises an annular groove extending helically in an outer surface of the mouth.
